(19) United States
(12) Patent Application Publication
(10) Pub. No.: US 2025/0307953 A1
(43) Pub. Date: Oct. 2, 2025

(54) SYSTEMS AND METHODS FOR DIGITALLY VERIFIED GRAPHICAL ELEMENTS

(71) Applicant: Meta Platforms, Inc., Menlo Park, CA (US)

(72) Inventor: Arun Karthick Manickam Alagar Muthumanickam, Lynnwood, WA (US)

(21) Appl. No.: 18/622,744

(22) Filed: Mar. 29, 2024

(51) Int. Cl. G06Q 50/00; H04W 4/021

(52) U.S. Cl. CPC G06Q 50/01; H04W 4/021

(57) ABSTRACT

The disclosed systems and methods may include (1) digitally verifying that a user of a social media application has attained an achievement, (2) in response to digitally verifying that the user has attained the achievement, providing the user with an option to digitally claim a graphical element corresponding to the achievement, where the option to digitally claim the graphical element is only provided to users who have been digitally verified as having attained the achievement, and (3) in response to receiving user input digitally claiming the graphical element, posting the graphical element to a digital user footprint corresponding to the user within a page of the social media application. Various other methods, systems, and computer-readable media are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a flow diagram of an exemplary method for digitally verified graphical elements.

FIG. 2 is a block diagram of an exemplary system for digitally verified graphical elements.

FIG. 3 is an illustration of an exemplary newsfeed interface.

FIG. 4 is an illustration of an exemplary digital stories interface.

FIG. 5 is an illustration of an exemplary short-form video consumption interface.

FIG. 6 is an illustration of an exemplary messaging interface.

FIG. 7 is an illustration of an exemplary videoconferencing interface.

FIG. 8 is an illustration of an exemplary workplace social media feed.

FIG. 9 is an illustration of an exemplary group page hosted by a social media platform.

FIG. 10 is an illustration of an exemplary graphical element claiming prompt in an exemplary social media user interface.

FIG. 11 is an illustration of an exemplary achievement digest interface displaying the graphical elements associated with claimed achievements of a user.

FIG. 12 is an illustration of an exemplary profile page of a user with an achievement highlights section displaying the graphical elements associated with claimed achievements of the user.

FIG. 13 is an illustration of an exemplary search page that enables a user to search for contacts who have claimed one or more achievements indicated in the search.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to a system for digitally verifying that a user of a social media application has attained an achievement. The user's achievement may be digitally verified in a variety of ways. In some examples, the achievement may be associated with an additional user and/or group (e.g., a user and/or group hosting an event associated with the achievement, accrediting the achievement, and/or creating a challenge associated with the achievement). For example, the achievement may represent running a marathon and the additional user and/or group may represent an entity hosting the marathon. As another example, the achievement may represent completing a challenge created by a social media influencer and the additional user and/or group may represent the social media influencer. As another example, the achievement may represent completing a degree and/or course with a university and the additional user and/or group may represent the university. In these examples, the user's achievement may be digitally verified via user input from the additional user (e.g., to an achievement verification page provided via the social media application).

In certain examples, the achievement may be automatically verified (e.g., based on data collected from a mobile device associated with a social media account of the user). As a specific example, the achievement may represent traveling to a certain location and this achievement may be verified in response to (1) the user posting content via the social media application, from the certain location, with location access enabled for the social media application, (2) GPS data indicating the certain location (e.g., collected by sensors of a mobile device on which the social media application is installed), and/or (3) location information indicating the certain location (e.g., received from an application linked to the social media application via a user permissions setting).

In some examples, once the user achievement is verified, the system may provide the user with an option to claim a graphical element corresponding to the achievement (e.g., an option only provided to users who have been verified as achieving the user achievement). For example, the system may provide a user who has been verified as traveling to Italy with a digital badge associated with having traveled to Italy (e.g., an icon that visually depicts having traveled to Italy). In these examples, the user may be enabled to post the graphical element to a digital user footprint via the social media application (e.g., to a profile and/or profile element, to a social media post, to a private digest of graphical achievement elements, etc.). In one embodiment, the system may allow users to search for others who have been verified for certain achievements and have claimed the corresponding graphical elements (e.g., with a query to find all contacts who have achieved a particular achievement). In this embodiment, the system may allow such users to send digital messages to the other users identified in the search. In this embodiment, the search results may depend on the privacy settings selected by each user shown in the search results.

As will be explained in greater detail below, embodiments of the present disclosure may improve the field of social networking by improving data culling, data organization, and data discovery (e.g., to present useful content to an end user via a digital organization that is easy to use). Embodiments of the present disclosure may improve a computer itself by improving data consumption flows and data organization.

The problem of verifying digitally provided user information has emerged alongside the proliferation of computer-based interactions and transactions. With the increasing reliance on digital platforms, the need to reliability authenticate user information (e.g., an assertion of an achievement) has become increasingly critical. Computers have facilitated convenient and efficient access to user-supplied information, but they have also introduced these new challenges related to security and trust. Thus, the disclosed achievement-verification system is a computer-based solution to a problem rooted in technology.

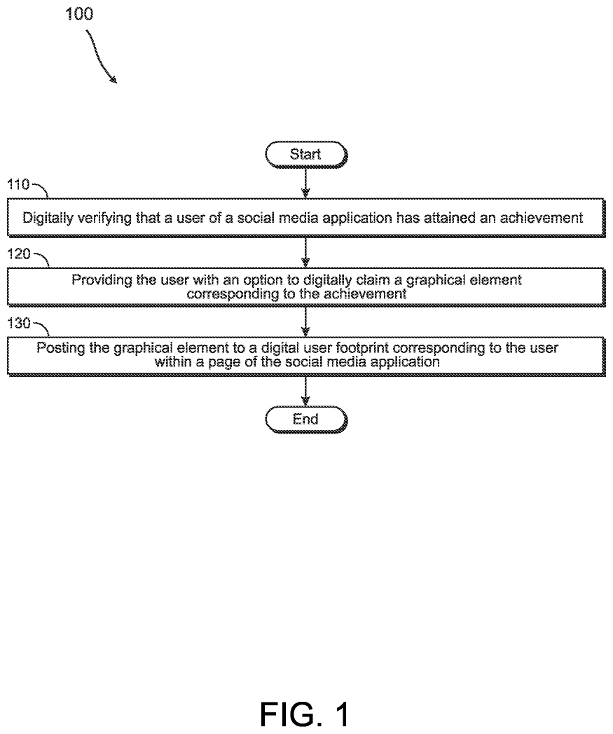

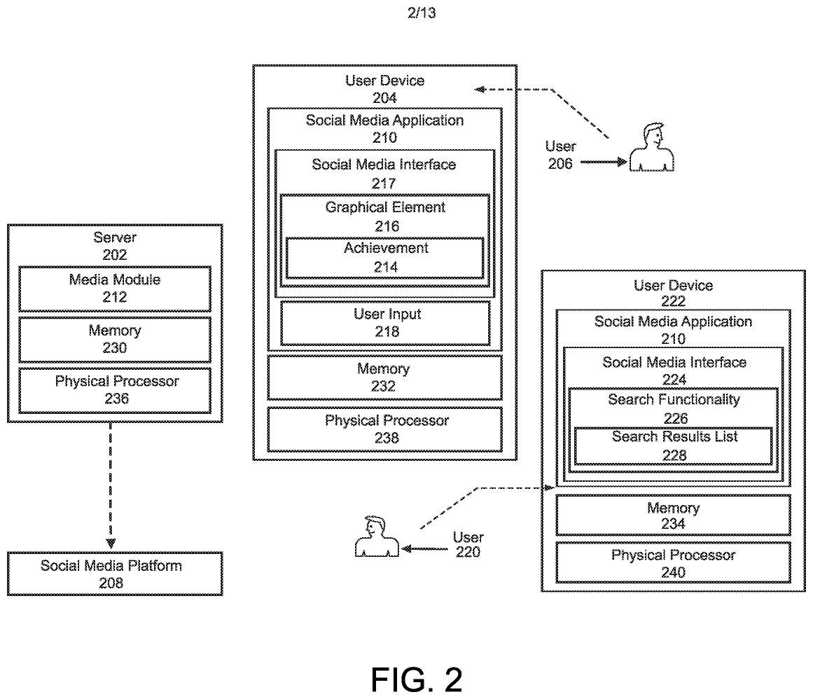

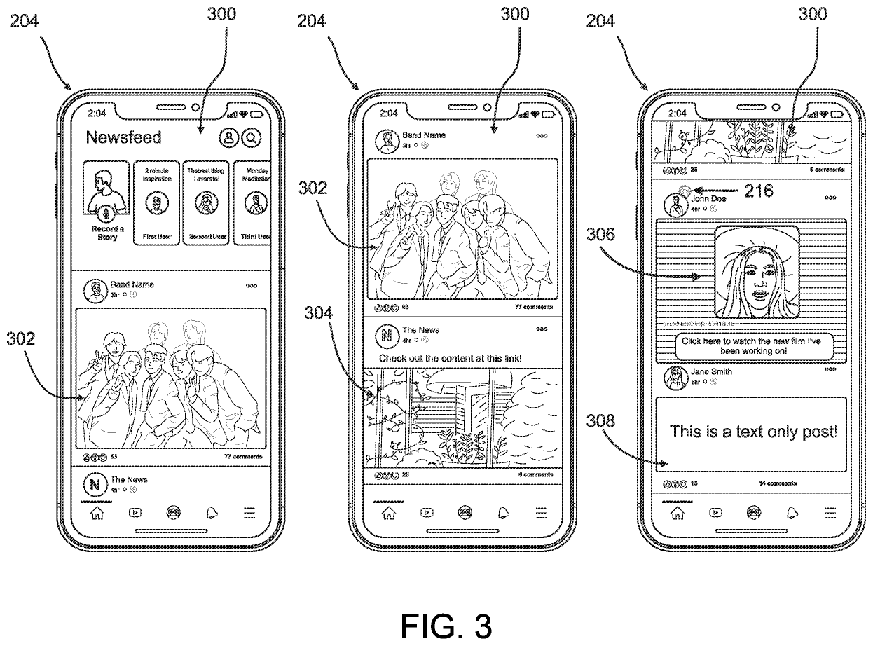

The following will provide, with reference to FIG. 1, detailed descriptions of computer-implemented methods for digital achievement verification (e.g., in a social media context). Detailed descriptions of corresponding example systems will also be provided in connection with FIG. 2. Detailed descriptions of interfaces and embodiments corresponding to the disclosed methods and systems will be provided in connection with FIGS. 3-13.

FIG. 1 is a flow diagram of an exemplary computer-implemented method 100. The steps shown in FIG. 1 may be performed by any suitable computer-executable code and/or computing system, including the system(s) illustrated in FIG. 2. For example, the steps shown in FIG. 1 may be performed by modules operating in a server 202 and/or modules operating in a user device 204 (associated with a user 206). In one example, each of the steps shown in FIG. 1 may represent an algorithm whose structure includes and/or is represented by multiple sub-steps, examples of which will be provided in greater detail below.

Server 202 generally represents any type or form of backend computing device that may perform one or more functions directed at social networking. The term “social networking” may refer to any type or form of digital communication that occurs between users of a social networking platform via an interface of the social networking platform. Examples of social networking may include, without limitation, text-based and/or image-based communication, video-based communication, audio-based communication, videoconferencing and/or audioconferencing, digital status broadcasting, private digital messaging, public content posting and/or commenting via a social media feed and/or a profile, etc. In some examples, server 202 may operate as part of and/or in connection with a social media platform 208. Although illustrated as a single entity in FIG. 2, server 202 may include and/or represent a group of multiple servers that operate in conjunction with one another.

User device 204 generally represents any type or form of computing device capable of reading computer-executable instructions. For example, user device 204 may represent a smart phone and/or a tablet. Additional examples of user device 204 may include, without limitation, a laptop, a desktop, a wearable device, a personal digital assistant (PDA), etc.

In some examples, user 206 of user device 204 may be a user (e.g., a member) of a social networking platform (e.g., social media platform 208). In these examples, user device 204 may have installed an instance of a social media application 210, which may operate as part of social media platform 208 and through which one or more services provided by social media platform 208 (e.g., via server 202) may be accessible. In some examples, social media application 210 may be dedicated to a single service. For example, social media application 210 may represent a dedicated newsfeed application, a dedicated messaging application, a dedicated short-form video application, etc. In other examples, social media application 210 may provide access to multiple services (e.g., a combination of two or more of the social networking services described below). In addition, or as an alternative, to social media application 210, user device 204 may have installed a browser that may navigate to one or more webpages through which the one or more services provided by social media platform 208 (e.g., via server 202) may also be accessible.

In some examples, the steps shown in FIG. 1 may be performed (at least in part) by modules operating in an additional user device. In these examples, the additional user device may include any of the features described above in connection with user device 204 and may have installed an additional instance of social media application 210, which may operate as part of social media platform 208 and through which one or more services provided by social media platform 208 (e.g., via server 202) may be accessible.

As mentioned above, social media platform 208 may provide a variety of services (e.g., platforms and/or frameworks) for the users within its network (e.g., via server 202 and/or social media application 210). For example, social media platform 208 may provide a newsfeed service. The term “newsfeed” may generally refer to any type or form of social media consumption channel, provided via an interface, that presents a scrollable collection of newsfeed posts. In some examples, a newsfeed may scroll (e.g., upward or downward) to reveal the different posts within the newsfeed (e.g., in response to receiving user scrolling input). In one example, the scrollable collection may include newsfeed posts created by contacts of a particular user (e.g., friends of the particular user) and/or other users that the particular user is following (i.e., connected content). Additionally, the newsfeed may include non-connected content (e.g., content created by users who are not contacts of the particular user).

The term “newsfeed post” generally refers to any type or form of digital composition that may be displayed in a newsfeed. Newsfeed posts may include a variety of content. For example, a newsfeed post may include, without limitation, text, an image, a video, a set of multiple images and/or videos, and/or a link (e.g., to a post, webpage, article, film, etc.). FIG. 3 depicts an exemplary newsfeed interface 300 with a newsfeed that includes an image-based newsfeed post 302, a link-based newsfeed post 304, a video-based newsfeed post 306, and a text-based newsfeed post 308.

In some examples, a newsfeed post may include a viewing pane for the content of the newsfeed post (e.g., the text in a text-based post, the image in an image-based post, etc.). A newsfeed post may also display a text-based caption, metadata content (e.g., content describing users that have been tagged in the newsfeed post, a timestamp, etc.), information indicating the source of the newsfeed post (e.g., the name of the creator of the post, a profile image, etc.), and/or a digital special effect (e.g., a digital sticker, a filter, an-augmented reality element, etc.). Such information and/or features may be displayed (and/or a menu corresponding to such information and/or features may be displayed) within the viewing pane (e.g., over the primary content), within the viewing pane and/or may be visually associated with the viewing pane (e.g., displayed beneath the viewing pane).

The newsfeed service may enable viewers of a newsfeed post to digitally respond to the newsfeed post in a variety of ways. In some examples, a newsfeed interface may enable a user to comment on a newsfeed post (e.g., via a text, image, and/or video-based reply) and may create a digital thread of comments corresponding to the newsfeed post (e.g., displayed beneath the newsfeed post and/or accessible via a comments affordance).

As another example, social media platform 208 may provide a digital stories service. The digital stories service may provide users with a digital stories feed, which presents a continuous series of digital story posts to a story-consumer, one by one (e.g., in a slideshow format). The term “digital story post” may generally refer to any type or form of digital composition intended for a digital stories feed. A digital story post may include a variety of content (e.g., a digital photograph, a graphic, text, a digital video, an artificial reality element, a digital audio recording, etc.). In one example, the story consumption channel may transition from presenting one digital story post to the next automatically, without requiring any user input to do so. In some examples, digital story posts from the same source (e.g., created and/or posted by the same user) may be grouped together, such that each digital story post from a particular source is displayed prior to displaying digital story posts from another source.

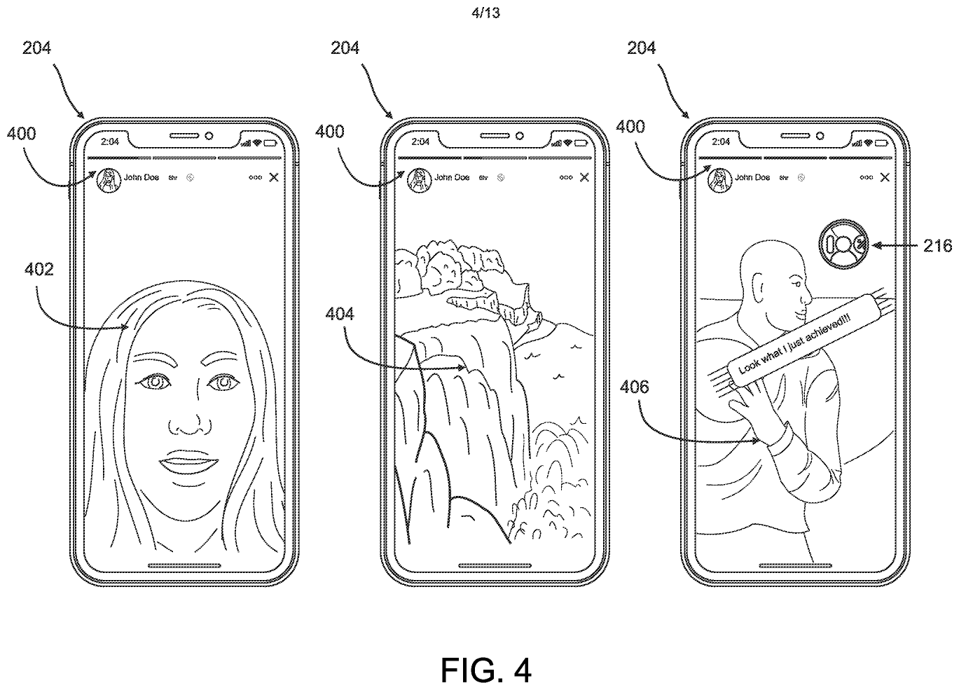

In one embodiment, a digital story post may be ephemeral. That is, the digital story post may only be viewable for a predetermined amount of time. For example, a digital story post may be set to disappear after twenty-four hours. Similar to the newsfeed service, the digital stories service may enable viewers of a story post to comment on the post, via a text and/or image-based reply and/or reply story, creating a digital thread of comments. Also similar to the newsfeed service, the digital stories service may configure a story feed for a particular user that includes connected content (e.g., story posts created by users who are contacts of the particular user or being followed by the particular user), non-connected content, or a determined ratio of connected content to non-connected content. FIG. 4 depicts an exemplary story interface 400 showing digital story posts 402, 404, and 406 of a user's digital story.

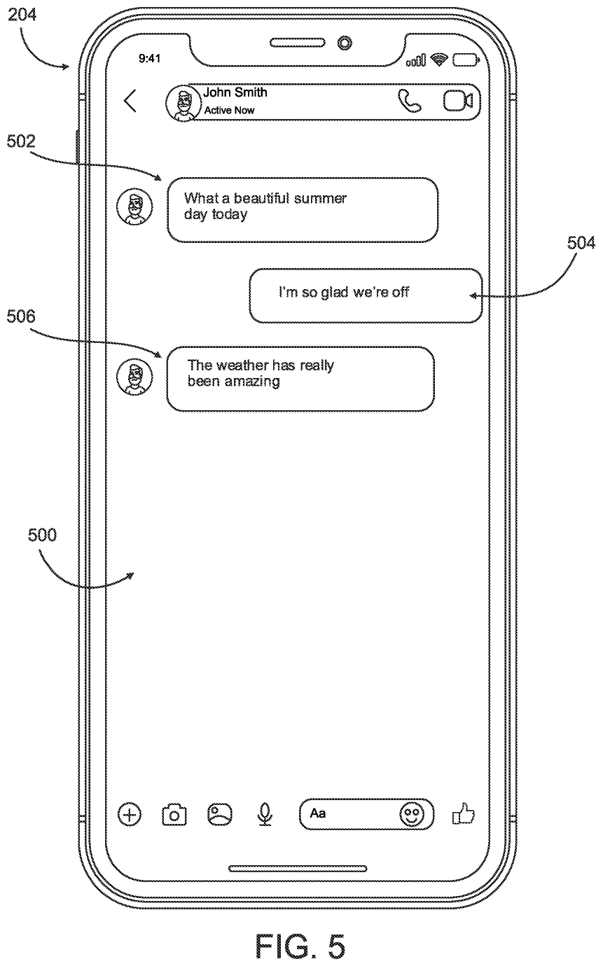

As another example, social media platform 208 may provide a messaging service. The term “messaging service” may generally refer to any type or form of digital message delivery system that enables users of social media platform 208 to exchange messages (e.g., text messages, audio messages, and/or video messages). FIG. 5 depicts an exemplary messaging interface 500 showing digital message posts 502, 504, and 506 of a digital messaging thread.

In some examples, social media platform 208 may provide a short-form video service (e.g., a reels service) that enables users to create short-form videos and/or consume (e.g., watch and/or digitally respond to) short-form videos created by other users. In one embodiment, social media platform 208 may create a short-form video feed for each user of its short-form video service. The term “short-form video” may generally refer to a digital video configured for short-form video feed consumption. In some examples, a platform for creating and/or posting a short-form video may only enable the creation and/or posting of short-form videos that are a certain length and/or that are less than a certain length (e.g., less than thirty seconds in length).

The term “short-form video feed” may generally refer to a series (e.g., a queue) of digital short-form videos (e.g., selected for a particular user) that social media application 210 (or a corresponding webpage) is configured to play, one by one, as a continuous series (e.g., advancing from one short-form video to the next automatically). In some examples, a short-form video feed may be configured to play short-form videos asynchronously (e.g., to play a continuously evolving queue of pre-recorded short-form videos). In some examples, short-form videos may be continuously added to a user's short-form video feed as the short-form videos of the feed are consumed (e.g., such that a determined number of short-form videos are always in queue to be played).

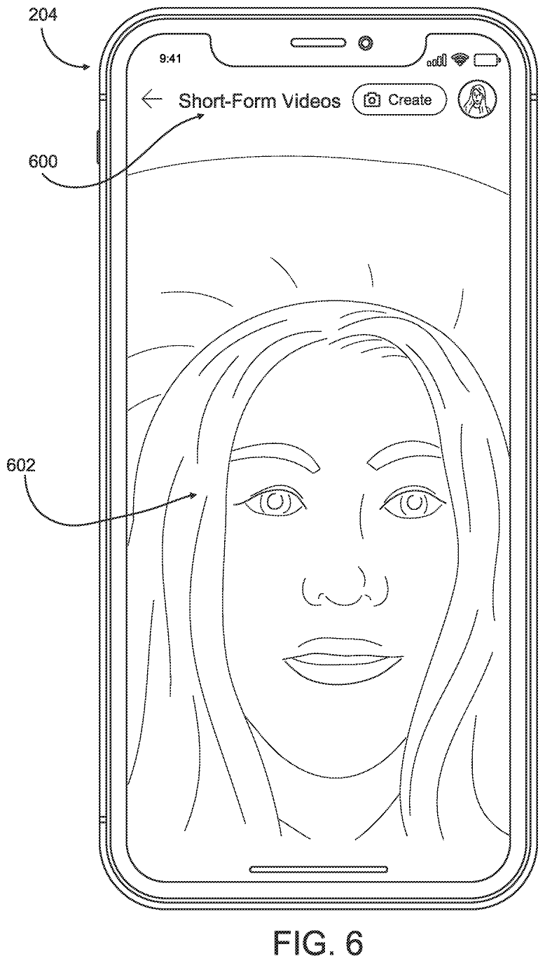

In some examples, a short-form video feed may be presented via a dedicated short-form video feed interface. FIG. 6 depicts an exemplary dedicated short-form video feed interface 600 presenting a short-form video 602. Short-form videos may be selected for the short-form video feed of a particular user based on a variety of metrics. For example, a short-form video may be selected based on a topic the short-form video has been tagged with (e.g., in response to a determination that the particular user is interested in and/or predicted to be interested in the topic). As another example, a short-form video may be selected based on a user who created the short-form video (e.g., in response to a determination that the particular user is following the user and/or is predicted to be interested in content by the creator). As another example, a short-form video may be selected based on a popularity of the short-form video.

In some embodiments, a short-form video may be displayed (e.g., streamed) with a variety of information relating to the short-form video. Such information may include, for example, a name and/or profile element of an account that created the short-form video, a title of the short-form video, viewer responses to the short-form video and/or an affordance that navigates to viewer responses to the short-form video, one or more elements for providing a digital social response to the short-form video, a transcript of the short-form video, etc.

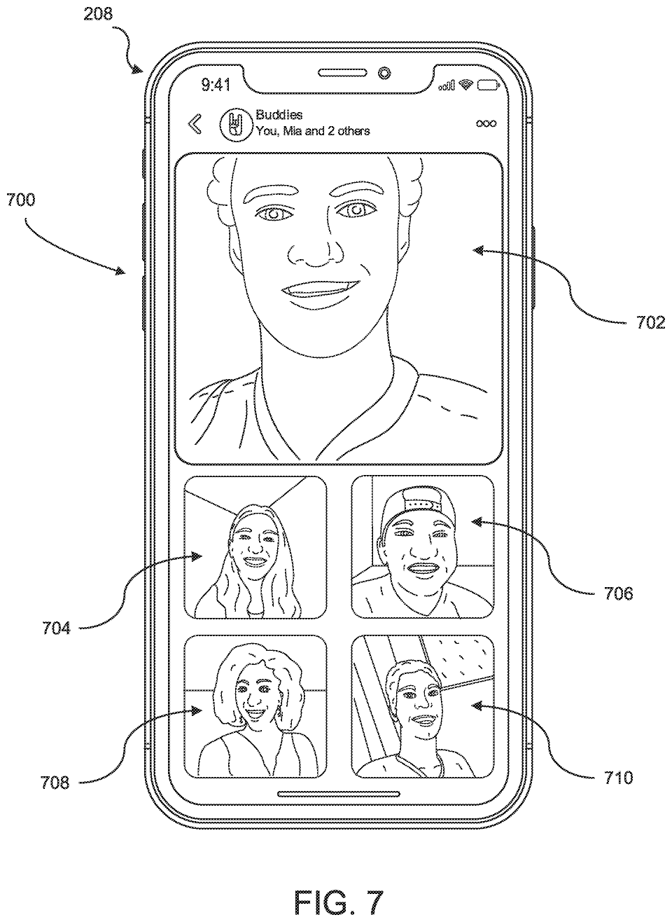

As another example, social media platform 208 may provide a media conferencing (e.g., audioconferencing and/or videoconferencing) service (e.g., a “rooms” service) for hosting media calls (e.g., audio calls and/or video calls). The media conferencing service may operate as a stand-alone service and/or may be integrated with another service (e.g., a messaging service, a social workplace service, etc.). The term “media conferencing service” refers to any type or form of streaming and/or videotelephony service that enables the digital transmission and/or sharing of real-time media (e.g., video and/or audio) streams (e.g., from multiple endpoints) via a media conferencing interface. The term “real-time media stream” generally refers to any type or form of multimedia that is transmitted in real time (e.g., as a series of frames) from an endpoint (i.e., a transmitting device) to one or more additional endpoints. Audio and/or frames may be played and/or displayed by an endpoint (to a user) as the audio and/or frames are received. FIG. 7 depicts an exemplary videoconferencing interface 700 with video tiles 702, 704, 706, 708, and 710 (each presenting a video stream of a user).

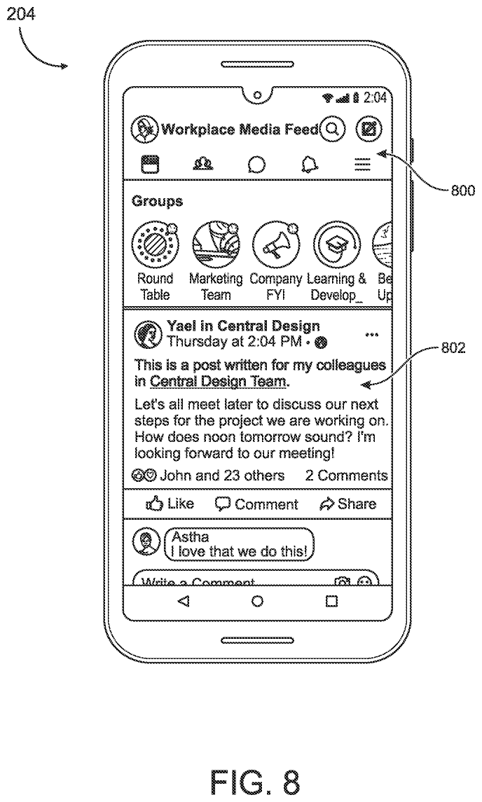

In some examples, social media platform 208 may provide a social workplace service that enables digital communication between employees of a workplace. The social workplace service may include any of the features and/or services described above (e.g., a workplace media feed, a workplace messaging service, a videoconferencing service, etc.). FIG. 8 provides an exemplary depiction of a workplace social media feed 800 in which social media compositions (e.g., composition 802), posted by users in a workplace environment (e.g., employees and/or managers of the workplace), are presented.

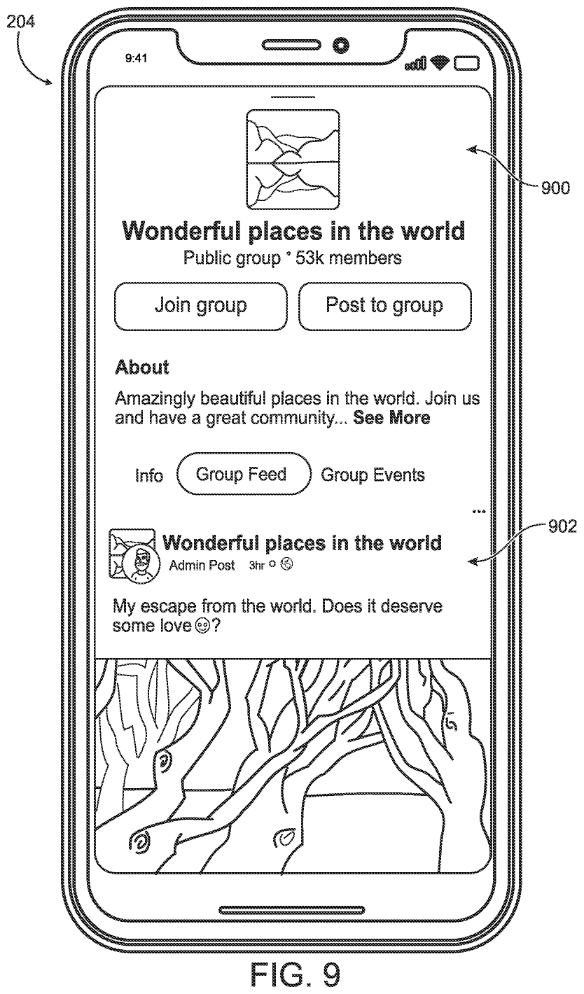

In some examples, social media platform 208 may provide a digital groups service that enables users to create and/or join digital groups. A digital group may correspond to a digital group page managed by a group administrator. The digital group page may include a variety of features and/or functionalities. In some examples, the group page may enable members to organize events. Additionally or alternatively, the digital group page may include a group feed of posts (e.g., posted to the digital group page by members of the digital group and/or by the group administrator). In some examples, a post of the group feed may be posted to the personal social media feeds of the digital group's members. FIG. 9 provides an exemplary depiction of a group page 900 with a group feed 902.

Returning to FIG. 1, at step 110, one or more of the systems described herein may digitally verify that a user of a social media application has attained an achievement. For example, as illustrated in FIG. 2, a media module 212 may digitally verify that user 206 of social media application 210 has attained (e.g., completed, achieved, finished, received) an achievement 214.

Achievement 214 may represent any type or form of achievement that can be digitally verified. In some examples, achievement 214 may represent a digital achievement (e.g., an online achievement). Additionally or alternatively, achievement 214 may represent a real world achievement. Specific examples of achievement 214 may represent, without limitation, completing a degree (e.g., an online degree and/or a traditional degree) and/or course, running a marathon, completing an online influencer challenge, purchasing a particular product, visiting a particular location, completing a workout, attending a webinar, finishing an e-book and/or an audiobook, winning a game and/or a tournament, etc. In some examples, achievement 214 may be associated with an additional user or group (e.g., a user and/or group hosting, promoting, and/or judging the achievement and/or an event associated with the achievement). For example, achievement 214 may represent a degree and the additional user or group may represent a university offering the degree. As another example, achievement 214 may represent a completing challenge and the additional user or group may represent a social media influencer who created the challenge (e.g., and/or who is monitoring and/or assessing the completion of the challenge). The term “influencer” may refer generally to any type or form of content creator on a social media platform (e.g., associated with social media application 210). In some examples, an influencer may represent a user associated with a designated type of social media account (e.g., a public account that may be followed by other user accounts).

In some examples, achievement 214 may be generated by a social media platform corresponding to social media application 210. In other examples, achievement 214 may be generated by a user of the social media platform (e.g., by an influencer, a private user account, a group page, a group account, etc.). (In these examples, the graphical elements that will be described later may be user configurable, as will be described in greater detail later).

Media module 212 may digitally verify achievement 214 in a variety of ways. As a specific example, achievement 214 may represent traveling to a particular location (e.g., San Diego) and media module 212 may digitally verify that user 206 has traveled to the location in response to user 206 posting content via social media application 210, from the certain location, with location access enabled for social media application 210. In these examples, social media application 210 may (e.g., as part of a content creation and posting process) identify a location of user 206 and the location identified may be used to determine (e.g., verify) that user 206 is in the location identified as part of the content creation and posting process.

In additional or alternative specific examples, media module 212 may digitally verify that user 206 has traveled to a certain location via data indicating the certain location (e.g., GPS data, Bluetooth data, WiFi data, etc.), collected by one or more sensors of a mobile device (e.g., user device 204) on which social media application 210 is installed. In one embodiment, media module 212 may digitally verify that user 206 has traveled to a location based on location information indicating the location that media module 212 receives (e.g., via an API) from an additional application linked to social media application 210 via (e.g., as permitted by) a user permissions setting. As a specific example of this, social media application 210 may be linked to a payment application. The payment application may identify a location of user 206 based on location information received from a registered payment center to which the payment application has made a payment. Then, media module 212 may receive this information (e.g., via an API) from the payment application.

In some examples in which achievement 214 is associated with an additional user and/or group, media module 212 may verify achievement 214 in response to receiving user input from the additional user and/or group verifying that user 206 has attained the achievement. In some such examples, the user input may be manually provided by the additional user and/or group. For example, the additional user and/or group may manually input a list of users who have completed achievement 214. In one embodiment, the verification may be automatic. As a specific example, achievement 214 may represent attending a webinar via a digital conferencing room configured by the additional user and/or group. In this specific example, achievement 214 may be automatically verified based on a determination that user 206 was logged into the webinar (e.g., for a specified duration).

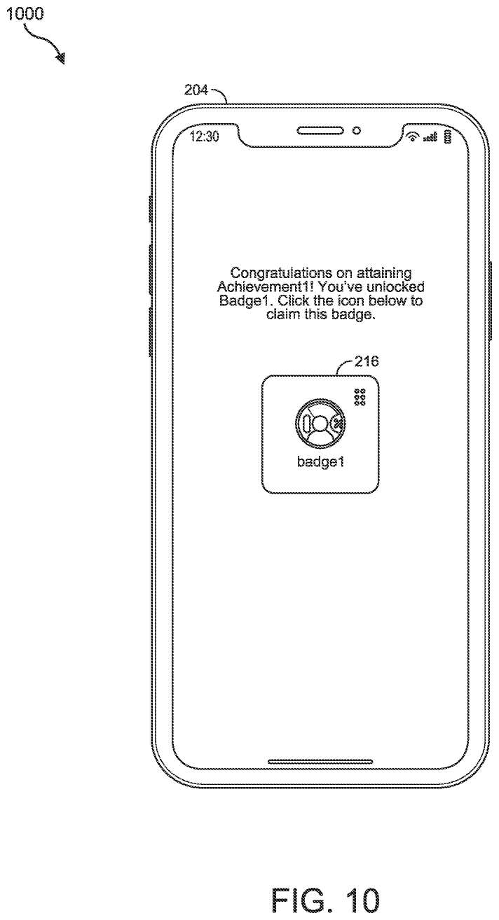

Returning to FIG. 1, at step 120, one or more of the systems described herein may, in response to digitally verifying that the user has attained the achievement, provide the user with an option to digitally claim a graphical element corresponding to the achievement, where the option to digitally claim the graphical element is only provided to users who have been digitally verified as having attained the achievement. For example, as illustrated in FIG. 2, media module 212 may, in response to digitally verifying that user 206 has attained achievement 214, provide user 206 with an option to digitally claim a graphical element 216 corresponding to achievement 214, where the option to digitally claim graphical element 216 is only provided to users who have been digitally verified as having attained achievement 214. FIG. 10 depicts an exemplary prompt in a social media interface 1000 providing user 206 with the option to digitally claim graphical element 216, according to one specific embodiment.

Graphical element 216 (e.g., a digital badge) may represent any visual component or object displayed on a user interface. Graphical element 216 may include any visual attribute (e.g., any size, shape, color, etc.). In examples in which achievement 214 was created by a user, graphical element 216 may also have been created by the user via a graphical element creation process (e.g., a “badges” creation process) provided via social media application 210. In some examples, graphical element 216 may include visual content associated with achievement 214 (e.g., a depiction of an activity corresponding to achievement 214) and/or visual content associated with a user associated with achievement 214. Graphical element 216 may be associated with a variety of data (e.g., a badge name, a certificate, a tagline, a description, etc.).

While this description focuses on an embodiment in which a graphical element is offered (and/or claimed), the disclosed systems may offer any type or form of digital content, such as a digital certificate and/or a digital designator, in response to digitally verifying that the user has attained the achievement. In these examples, any of the features discussed herein with respect to the graphical element may be applied to this digital content.

Media module 212 may provide user 206 with the option to digitally claim graphical element 216 in a variety of ways. In some examples, media module 212 may provide user 206 with the option to digitally claim graphical element 216 by prompting user 206 to digitally claim graphical element 216 (e.g., via a notification as shown in FIG. 10). Additionally or alternatively, media module 212 may provide user 206 with the option to digitally claim graphical element 216 by adding graphical element 216 to a database of available graphical elements (e.g., available “badges”) that user 206 is able to claim (e.g., graphical elements associated with achievement which user 206 has been verified as attaining).

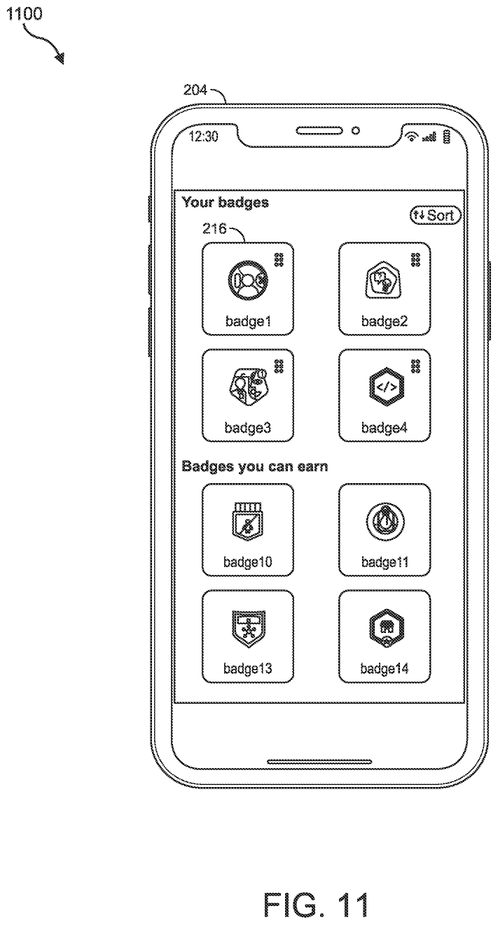

The phrase “claiming a graphical element” may refer to any type or form of process that enables user 206 to digitally access, acquire, and/or use the graphical element. In some examples, “claiming a graphical element” may include sharing the graphical element (e.g., within a digital footprint of the social media application corresponding to the user). Additionally or alternatively, “claiming a graphical element” may include adding the graphical element to a private collection (e.g., a private database) of graphical elements. FIG. 11 provides an exemplary depiction of a private collection interface 1100 of claimed graphical elements corresponding to verified achievement. In some examples, “claiming a graphical element” may include having permission to alternate between showing the badge (e.g., in a shared digital footprint) and hiding the badge (e.g., from the shared digital footprint).

Returning to FIG. 1, at step 130, one or more of the systems described herein may, in response to receiving user input digitally claiming the graphical element, post the graphical element to a digital user footprint corresponding to the user within a page of the social media application. For example, as illustrated in FIG. 2, media module 212 may, in response to receiving user input 218 digitally claiming graphical element 216, post graphical element 216 to a digital user footprint corresponding to user 206 within a social media interface 217 of social media application 210.

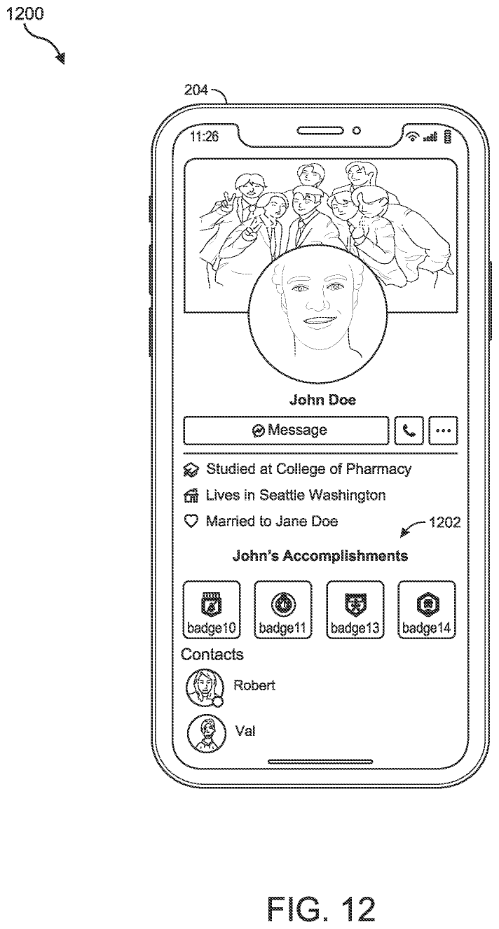

Media module 212 may post graphical element 216 to any type or form of digital user footprint within any type or form of social media interface. In some examples, media module 212 may post graphical element 216 to a private interface that shows user 206 which graphical elements user 206 has claimed (e.g., as shown in FIG. 11). In some examples, media module 212 may post graphical element 216 to a digital profile of user 206 (e.g., to a highlights section of the user's digital profile). FIG. 12 depicts an exemplary profile page 1200 with a verified-badges subsection 1202 of a highlights portion of profile page 1200. In these examples, the graphical elements (e.g., digital badges) corresponding to the verified achievements of user 206 may be displayed in any configuration (e.g., as circular elements beneath a user's profile banner, as a digital ribbon of banners, as a vertically scrollable collection of graphical elements, etc.). In some examples, the disclosed system may automatically determine an order in which to display the graphical elements and/or a relative size for the graphical elements (e.g., based on a recency metric and/or some other metric relating to a relative importance of the various achievements and/or a relative relevance of the various achievements to a viewer of the graphical elements). In some examples, the system may enable user 206 to configure a presentation of the graphical elements (e.g., enabling user 206 to rearrange the graphical elements within a screen and/or determine which elements to show or hide).

In some examples, media module 212 may post graphical element 216 as a profile element (e.g., attached to a profile of user 206). FIG. 3 provides an exemplary depiction in which graphical element 216 is affixed to a profile element of a user associated with post 306. In one embodiment, media module 212 may post graphical element 216 as a social media post. In this embodiment, media module 212 may provide user 206 with a post creation process that enables user 206 to add graphical element 216 to the post. FIG. 4 provides an exemplary depiction in which graphical element 216 has been added to post 406.

In some examples, media module 212 may be configured to automatically post graphical element 216 to the digital footprint in response to receiving user input 218 digitally claiming graphical element 216. In other examples, media module 212 may, in response to receiving user input 218 digitally claiming graphical element 216 (1) add graphical element 216 to a database of claimed graphical elements available for user 206 to post and/or (2) post graphical element 216 to the digital footprint based further on additional user posting input selecting (e.g., specifically requesting) to post graphical element 216 to the digital footprint. In some examples, the prompt (enabling user 206 to select a digital footprint to which to post graphical element 216) may be provided as part of (1) an initial prompt prompting user 206 to claim graphical element 216, (2) a digital element digest interface showing user 206 each of user 206's claimed digital elements, and/or (3) a digital content creation and/or profile curation process.

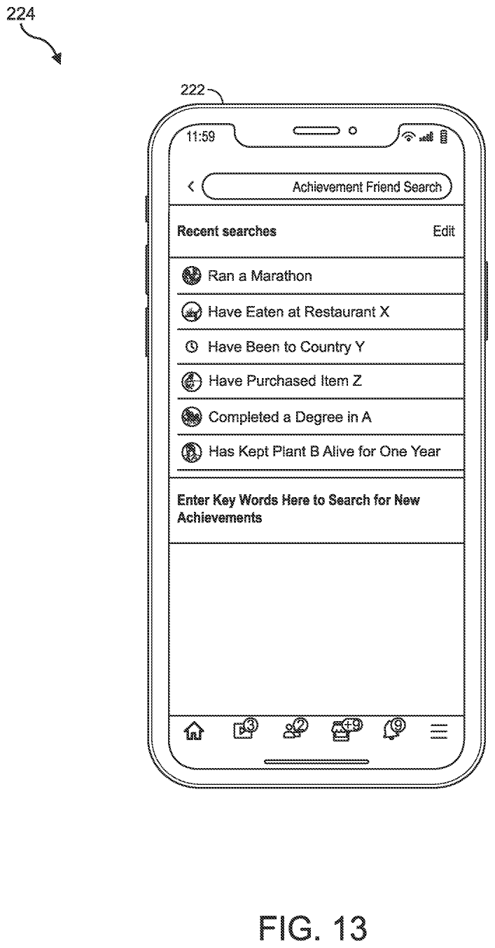

In certain examples, media module 212 may additionally enable a user (e.g., a user 220 of user device 222 in FIG. 2) to search for users who have attained a specific achievement, such as achievement 214, or a specific set of achievements (e.g., by providing the user with a social media interface 224 with a search functionality 226). In response, media module 212 may return a search results list 228 with the names of the user accounts of users who have claimed a digital element corresponding to specific achievement. In one such example, media module 212 may enable the user who generated the search to digitally correspond with the users provided in the search results list, or a selected subset of the users, from social media interface 224 (e.g., by enabling the user to send a selective-audience post to the users or selected subset of users, by sending a digital message to the users or selected subset of users, etc.). In these embodiments, each user may be provided with a permissions process that enables the user to decide whether the user will appear in the search results of users and/or to restrict the user's appearance in search results. For example, a user may restrict the user's appearance to only appear in the search results of searches completed by contacts of the user and/or completed by an enumerated set of the user's contacts. FIG. 13 provides an exemplary depiction of social media interface 224, according to one embodiment.

In one embodiment, graphical element 216 may represent a transferrable element (e.g., which user 206 may transfer to an additional user for the additional user to claim). In some such embodiments, some graphical elements may be configured as transferrable and other graphical elements may be configured as non-transferrable. Additionally or alternatively graphical element 216 may represent a shareable element. As a specific example, if achievement 214 is traveling to a particular location, user 206 has traveled to the particular location with user 220, and user 206 claims graphical element 216 in response to having been verified as having traveled to the particular location, user 206 may share graphical element 216 with user 220. In some examples, user 220 may be digitally verified for achievement 214 in a separate digital verification process (e.g., in response to verifying that user 220 is within a designated geographical area of user 206). In other examples, user 206 may verify that user 220 also qualifies to claim graphical element 216 (e.g., in response to user 206 having been verified).

User interfaces corresponding to the methods and systems described above may be surfaced as part of a variety of navigational flows (e.g., a variety of profile curation flows and/or a variety of post creation flows). In some examples, a navigational flow may include a combination of user interfaces described herein and additional user interfaces not described herein. Each user interface described herein may be surfaced from a variety of entry points. In some examples, the user interfaces described here may be interconnected (e.g., with one interface navigating to another).

In the embodiments depicted in the figures herein (e.g., FIGS. 3-13), the exemplary interfaces have been optimized for a mobile device. Additional or alternative embodiments of these exemplary interfaces may be optimized for other types of computing devices (e.g., a desktop computer, a laptop computer, a wearable device, etc.). In some examples, some or all of the content of these interfaces may be dynamically modified (e.g., customized for a particular user). For example, posts within a social media feed may be dynamically selected (e.g., based on a variety of inputs, as will be described in greater detail below).

Each of the computer-mediated actions described herein may be performed by a module (e.g., media module 212) that operates within an endpoint device (e.g., user device 204 and/or user device 222) and/or that operates within a backend server (e.g., server 202). In the examples in which an action involves presenting digital content to a user via an endpoint device and/or receiving user input and/or digital feedback from the user to the endpoint device, the module may perform the action directly, in examples in which the module operates within the endpoint device (e.g., by displaying content via a display element of the endpoint, receiving tapping input to a touchscreen of the endpoint device, and/or receiving input to an auxiliary device communicatively coupled to the endpoint device such a digital mouse and/or a keyboard), and/or indirectly (e.g., in examples in which the module operates within the server). In examples in which a module performs an action indirectly, the module may perform the action in a variety of ways. For example, the module may perform the action by instructing the endpoint device to perform the action, by transmitting content to the endpoint device to be presented by the endpoint device, by providing the endpoint with an application (e.g., social media application 210) that performs the action, by receiving an indication of user input to the endpoint device from the endpoint device, etc. Additionally, in some examples, the module may perform an action operating in a combination of an endpoint device and a backend server.

Each of the digital actions described above may be performed in conjunction with a permissions framework (e.g., a data privacy framework) that enables a user to select how data is selected for the user, how data relating to the user is collected, and how data relating to the user is shared with other users. In some examples, user 206 may provide permission for an action via a digital permissions process (e.g., via input to a permissions menu and/or page). In some examples, the digital permissions process may be directed to selecting an audience for a user generated post. Additionally or alternatively, the digital permissions process may be directed to permitting information about the user (e.g., a status and/or availability) to be broadcast (e.g., within a profile element and/or contact list). As another example, the digital permissions process may be directed to collecting user history (e.g., to apply to a machine learning system used to select content for the user).

In some of the embodiments described above, the disclosed systems may enable a user to create content (e.g., a social media post for a social media feed and/or a digital message for a private digital messaging thread) via a content-creation interface. In these embodiments, the content-creation interface may enable a content creation that includes a variety of types of content. Such content may include, without limitation, an image, a video, audio content, a graphic (e.g., a digital sticker), a special effect (e.g., an augmented reality effect), a filter, etc. The content-creation interface may enable a user to provide content (e.g., for a digital composition such as a post and/or message) in a variety of ways. In some examples, the content-creation interface may enable a user to create (e.g., generate) content via the content-creation interface. For example, the content-creation interface may include a digital canvas that enables a user to digitally draw content and/or may include a capture screen that enables the user to capture visual content via a camera of the user's device and/or audio content via a microphone of the user's device. As another example, the content-creation interface may include a text-input box that enables the user to input text (e.g., via typing input). Additionally or alternatively, the content-creation interface may enable the user to upload content. For example, the content-creation interface may include a drag-and-drop functionality and/or may present content (e.g., images stored in a camera roll of the user's device where permission to access the images has been provided) that may be selected to be included in the user's content creation. In addition to enabling a user to provide (e.g., create and/or upload) content, the content-creation interface may enable a user to modify (e.g., customize) content. For example, the content-creation interface may include a text-customization feature that enables a user to customize the appearance of text (e.g., selecting a size, color, font, and/or position of text). As another example, the content-creation interface may enable a user to select a filter and/or special effect to be applied over content.

In some of the embodiments described above, a module (e.g., media module 212) may select content for user 206. For example, a module may select social media consumption content for user 206 (e.g., a social media composition for a social media feed and/or a social media feed relating to a particular topic or theme) and/or suggested additional users for user 206 (e.g., users with whom to co-view a social media feed, a digital group to join, etc.). In these embodiments, the module may select content for user 206 in a variety of ways. For example, social media consumption content may be selected based on a relationship between user 206 and a creator of the social media consumption content (e.g., in response to determining that the creator is a contact of user 206 and/or that user 206 is following the creator), a user history and/or demographic of user 206 (e.g., indicative of a user interest), user data relating to a contact of user 206 and/or users with a features in common with user 206, etc. As another example, an additional user may be selected for user 206 based on a relationship between user 206 and the additional user (e.g., a relationship claimed by user 206 within social media platform 208, a number of social connections between user 206 and the additional user such as a number of mutual contacts, and/or a metric relating to an amount of digital interaction between user 206 and the additional user within social media platform 208). In some examples, content may be selected for user 206 by a machine learning system (e.g., a neural network). In these examples, the machine learning system may select the content in response to receiving a variety of inputs. Such inputs may include inputs relating to user 206 (e.g., an input derived from a user history, an expressed user preference, etc.), inputs relating to users with a features in common with user 206, inputs relating to a demographic and/or a region associated with user 206, inputs derived from a social graph, inputs relating to potential content that may be selected for user 206 (e.g., a topic of such content and/or a popularity of such content), etc.

### Example Embodiments

Example 1. A computer-implemented method including (1) digitally verifying that a user of a social media application has attained an achievement, (2) in response to digitally verifying that the user has attained the achievement, providing the user with an option to digitally claim a graphical element corresponding to the achievement, where the option to digitally claim the graphical element is only provided to users who have been digitally verified as having attained the achievement, and (3) in response to receiving user input digitally claiming the graphical element, posting the graphical element to a digital user footprint corresponding to the user within a page of the social media application.

Example 2. The computer-implemented method of example 1, where the achievement is traveling to a certain location, and digitally verifying that the user has attained the achievement includes verifying that the user has traveled to the certain location in response to at least one of the user posting content via the social media application, from the certain location, with location access enabled for the social media application, determining the certain location based on GPS data, indicating the certain location, collected by one or more sensors of a mobile device on which the social media application is installed, or determining the certain location based on location information, indicating the certain location, received from an application linked to the social media application via a user permissions setting.

Example 3. The computer-implemented method of examples 1-2, where the achievement is associated with an additional user or group, and digitally verifying that the user has attained the achievement includes receiving user input from the additional user or group verifying that the user has attained the achievement.

Example 4. The computer-implemented method of examples 1-3, where providing the user with the option to digitally claim the graphical element including prompting the user to digitally claim the graphical element via a user interface of the social media application.

Example 5. The computer-implemented method of examples 1-4, where the digital footprint includes a digital profile of the user.

Example 6. The computer-implemented method of example 5, where posting the graphical element to the digital user footprint includes posting the graphical element to a highlights section of the user's digital profile.

Example 7. The computer-implemented method of examples 1-6, where the digital footprint includes a profile element.

Example 8. The computer-implemented method of examples 1-7, where the digital footprint includes a social media post.

Example 9. The computer-implemented method of examples 1-8, where the digital footprint includes (e.g., is) a ribbon of claimed graphical elements, each of which corresponds to a different verified achievement.

Example 10. The computer-implemented method of examples 1-9, further including enabling an additional user to search for users who have attained the achievement, and returning, within a search results list, a name of a user account of the user.

Example 11. The computer-implemented method of example 10, further including enabling the additional user to digitally correspond with users listed in the search results list.

Example 12. A system including at least one physical processor, and physical memory including computer-executable instructions that, when executed by the physical processor, cause the physical processor to digitally verify that a user of a social media application has attained an achievement, in response to digitally verifying that the user has attained the achievement, provide the user with an option to digitally claim a graphical element corresponding to the achievement, where the option to digitally claim the graphical element is only provided to users who have been digitally verified as having attained the achievement, and in response to receiving user input digitally claiming the graphical element, post the graphical element to a digital user footprint corresponding to the user within a page of the social media application.

Example 13. The system of example 12, where the achievement is traveling to a certain location, and digitally verifying that the user has attained the achievement includes verifying that the user has traveled to the certain location in response to at least one of the user posting content via the social media application, from the certain location, with location access enabled for the social media application, determining the certain location based on GPS data, indicating the certain location, collected by one or more sensors of a mobile device on which the social media application is installed, or determining the certain location based on location information, indicating the certain location, received from an application linked to the social media application via a user permissions setting.

Example 14. The system of examples 12-13, where the achievement is associated with an additional user or group, and digitally verifying that the user has attained the achievement includes receiving user input from the additional user or group verifying that the user has attained the achievement.

Example 15. The system of examples 12-14, where providing the user with the option to digitally claim the graphical element including prompting the user to digitally claim the graphical element via a user interface of the social media application.

Example 16. The system of examples 12-15, where the digital footprint includes a digital profile of the user.

Example 17. The system of examples 12-16, where the digital footprint includes a profile element.

Example 18. The system of examples 12-17, where the digital footprint includes a social media post.

Example 19. The system of examples 12-18, where the computer-executable instructions further cause the physical processor to enable an additional user to search for users who have attained the achievement, and return, within a search results list, a name of a user account of the user.

Example 20. A non-transitory computer-readable medium including one or more computer-readable instructions that, when executed by at least one processor of a computing device, cause the computing device to digitally verify that a user of a social media application has attained an achievement, in response to digitally verifying that the user has attained the achievement, provide the user with an option to digitally claim a graphical element corresponding to the achievement, where the option to digitally claim the graphical element is only provided to users who have been digitally verified as having attained the achievement, and in response to receiving user input digitally claiming the graphical element, post the graphical element to a digital user footprint corresponding to the user within a page of the social media application.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device (e.g., memory devices 230, 232, and 234 in FIG. 2) and at least one physical processor (e.g., physical processors 236, 238, and 240 in FIG. 2).

The term “memory device” generally represents any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may transform a processor, volatile memory, non-volatile memory, and/or any other portion of a physical computing device from one form to another by executing on the computing device, storing data on the computing device, and/or otherwise interacting with the computing device.

The term “computer-readable medium” may refer to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
digitally verifying that a user of a social media application has attained an achievement;
in response to digitally verifying that the user has attained the achievement, providing the user with an option to digitally claim a graphical element corresponding to the achievement, wherein the option to digitally claim the graphical element is only provided to users who have been digitally verified as having attained the achievement; and
in response to receiving user input digitally claiming the graphical element, posting the graphical element to a digital user footprint corresponding to the user within a page of the social media application.

2. The computer-implemented method of claim 1, wherein:
the achievement is traveling to a certain location; and
digitally verifying that the user has attained the achievement comprises verifying that the user has traveled to the certain location in response to at least one of:
the user posting content via the social media application, from the certain location, with location access enabled for the social media application;
determining the certain location based on GPS data, indicating the certain location, collected by one or more sensors of a mobile device on which the social media application is installed; or
determining the certain location based on location information, indicating the certain location, received from an application linked to the social media application via a user permissions setting.

3. The computer-implemented method of claim 1, wherein:
the achievement is associated with an additional user or group; and
digitally verifying that the user has attained the achievement comprises receiving user input from the additional user or group verifying that the user has attained the achievement.

4. The computer-implemented method of claim 1, wherein providing the user with the option to digitally claim the graphical element comprising prompting the user to digitally claim the graphical element via a user interface of the social media application.

5. The computer-implemented method of claim 1, wherein the digital footprint comprises a digital profile of the user.

6. The computer-implemented method of claim 5, wherein posting the graphical element to the digital user footprint comprises posting the graphical element to a highlights section of the user's digital profile.

7. The computer-implemented method of claim 1, wherein the digital footprint comprises a profile element.

8. The computer-implemented method of claim 1, wherein the digital footprint comprises a social media post.

9. The computer-implemented method of claim 1, wherein the digital footprint comprises a ribbon of claimed graphical elements, each of which corresponds to a different verified achievement.

10. The computer-implemented method of claim 1, further comprising:
enabling an additional user to search for users who have attained the achievement; and
returning, within a search results list, a name of a user account of the user.

11. The computer-implemented method of claim 10, further comprising enabling the additional user to digitally correspond with users listed in the search results list.

12. A system comprising:
at least one physical processor; and
physical memory comprising computer-executable instructions that, when executed by the physical processor, cause the physical processor to:
digitally verify that a user of a social media application has attained an achievement;
in response to digitally verifying that the user has attained the achievement, provide the user with an option to digitally claim a graphical element corresponding to the achievement, wherein the option to digitally claim the graphical element is only provided to users who have been digitally verified as having attained the achievement; and
in response to receiving user input digitally claiming the graphical element, post the graphical element to a digital user footprint corresponding to the user within a page of the social media application.

13. The system of claim 12, wherein:
the achievement is traveling to a certain location; and
digitally verifying that the user has attained the achievement comprises verifying that the user has traveled to the certain location in response to at least one of:
the user posting content via the social media application, from the certain location, with location access enabled for the social media application;
determining the certain location based on GPS data, indicating the certain location, collected by one or more sensors of a mobile device on which the social media application is installed; or
determining the certain location based on location information, indicating the certain location, received from an application linked to the social media application via a user permissions setting.

14. The system of claim 12, wherein:
the achievement is associated with an additional user or group; and
digitally verifying that the user has attained the achievement comprises receiving user input from the additional user or group verifying that the user has attained the achievement.

15. The system of claim 12, wherein providing the user with the option to digitally claim the graphical element comprising prompting the user to digitally claim the graphical element via a user interface of the social media application.

16. The system of claim 12, wherein the digital footprint comprises a digital profile of the user.

17. The system of claim 12, wherein the digital footprint comprises a profile element.

18. The system of claim 12, wherein the digital footprint comprises a social media post.

19. The system of claim 12, wherein the computer-executable instructions further cause the physical processor to:
enable an additional user to search for users who have attained the achievement; and
return, within a search results list, a name of a user account of the user.

20. A non-transitory computer-readable medium comprising one or more computer-readable instructions that, when executed by at least one processor of a computing device, cause the computing device to:
digitally verify that a user of a social media application has attained an achievement;
in response to digitally verifying that the user has attained the achievement, provide the user with an option to digitally claim a graphical element corresponding to the achievement, wherein the option to digitally claim the graphical element is only provided to users who have been digitally verified as having attained the achievement; and
in response to receiving user input digitally claiming the graphical element, post the graphical element to a digital user footprint corresponding to the user within a page of the social media application.
